(19) United States
(12) Patent Application Publication
(10) Pub. No.: US 2012/0240823 A1
(43) Pub. Date: Sep. 27, 2012

(54) Glass Flake Pigments and Substrates

(76) Inventor: Charles Watkinson, Yorkshire (GB)

(21) Appl. No.: 13/450,129

(22) Filed: Apr. 18, 2012

Related U.S. Application Data
(63) Continuation of application No. 12/679,256, filed on Jul. 1, 2010, now abandoned.

(30) Foreign Application Priority Data
Sep. 20, 2007 (GB) 0718357.7

(51) Int. Cl. C08K 3/40

(52) U.S. Cl. 106/444

(57) ABSTRACT

Pigments formed from glass flakes which have a wide variety of uses, for instance, in paints, in ink jet printing, dyeing textiles, in coatings, printing inks, plastics, cosmetics, glazes for ceramics and glass. Also provided is a glass flake substrate for the pigments.

### CROSS-REFERENCE TO RELATED APPLICATIONS

This application is a continuation of U.S. application Ser. No. 12/679,256 filed Jul. 1, 2010 which is a U.S. National Phase (371) of PCT Patent Application No. PCT/GB2008/003163 filed Sep. 22, 2008 and claims priority to United Kingdom Patent Application No. GB 0718357.7 filed Sep. 20, 2007 the disclosures of which are incorporated herein by reference in their entirety for all purposes.

### FIELD OF THE INVENTION

This invention relates to pigments formed from glass flakes which have a wide variety of uses, for instance, in paints, in ink-jet printing, dyeing textiles, in coatings, printing inks, plastics, cosmetics, glazes for ceramics and glass. The invention also relates to substrates for such pigments.

### BACKGROUND TO THE INVENTION

Various proposals have been made for coating transparent carrier materials such as silica or glass with materials of high refractive index providing so-called interference or effect pigments.

The composition of the coating, as well as the nature, shape and size of the carrier material, is crucial to the cost effectiveness and efficacy of the resulting pigment.

### STATEMENTS OF THE INVENTION

According to the present invention there is provided a pigment comprising glass flakes at least partially coated with a material having a high refractive index, the glass flakes comprising the following: [0005] silica—50 to 80 [0006] alumina—1 to 20 [0007] titania—up to 20

Preferred pigments include those with glass flakes comprising the following: [0009 ] silica—65 to 75 [0010] alumina—2 to 5 [0011] titania—up to 5

The amounts recited above are expressed in % by weight, based on the weight of glass flakes. [0013] Preferably, the thickness of the glass flakes is less than 5 μm, more preferably less than 1 μm and most preferably from 20 to 500 μm. [0014] Preferably, the refractive index of the coating is at least 1.5, more preferably at least 1.6 and most preferably at least 1.8.

The glass flakes of the present invention may have a coating including a relatively high refractive index layer and a relatively low refractive index layer. The material of relatively low reflective index may have a refractive index of, for instance, less than 1.7. In general the refractive index of this layer should be less than that of the relatively high refractive index layer.

Examples of materials which may be utilised in the low reflective index layer are silica and alumina.

The average particle size of the glass flakes of use in the present invention is preferably from 1 to 1000 μm, more preferably up to 500 μm, most preferably up to 200 μm.

The aspect ratio of the glass flakes for use in the present invention is preferably at least 20 or more preferably at least 50. The thickness of the layer of high refractive material is at least 0.1 nm, preferably at least 5 nm and more preferably in the range from 10 to 200 nm.

The pigments of the present invention can be used in a wide variety of applications, for instance, printing inks, automotive coatings, cosmetic formulations and in the colouring of plastics, glasses, ceramic products and agricultural films.

Various methods can be used for coating the glass flakes to produce the pigments of the present invention. These include wet chemical coating, physical vapour deposition, chemical vapour deposition and electroless plating.

The invention also provides glass flake substrate for use in the pigments of the invention.

### DETAILED DESCRIPTION OF THE INVENTION

A pigment in accordance with the present invention includes LAG6 glass flakes made by Glassflake Ltd which have an average thickness of about 210 nm and a BET of 2.2 m²/g. These glass flakes have been milled and sieved to obtain flakes of a size between 20 and 100 microns.

The composition of the LAG6 glass is as follows (% by weight based on the weight of glass flakes):—SiO.sub.₂69.30; TiO.sub.₂1.48; Al.sub.₂O.sub.₃; 3.60; Fe.sub.₂O.sub.₃ 0.15; CaO 2.10; MgO 1.22; K.sub.₂O 2.00; Na.sub.₂O 9.44; ZrO.sub.₂0.24; B.sub.₂O.sub.₃10.42; others 0.05. The ferric oxide and zirconia are present as unavoidable contaminants. “Others” are contaminant elements of less than one decimal place.

Coating the glass flakes with titania by depositing from a TiCl.sub.₄ solution produced a smooth coating which had excellent colour and lustre and gave very good mechanical stability.

1. A pigment comprising a glass flake, said glass flake being at least partially coated with a first material having a refractive index of at least 1.8, and said glass flake having the following approximate composition:

| | | |
|---|---|---|
| SiO₂ | 69 | wt % |
| TiO₂ | 1.5 | wt % |
| Al₂O₃ | 3.5 | wt % |
| CaO | 2.25 | wt % |
| MgO | 1.25 | wt % |
| K₂O | 2 | wt % |
| Na₂O | 9.5 | wt % |
| B₂O₃ | 10.5 | wt % |
| Others | 0.5 | wt %, |

wherein the wt % is based on the weight of glass flake.

2. A pigment according to claim 1, wherein the thickness of the glass flakes is less than 5 μm.

3. A pigment according to claim 2, wherein the thickness of the glass flakes is less than 1 μm.

4. A pigment according to claim 3, wherein the thickness of the glass flakes is from 20 to 500 nm.

5. A pigment according to claim 1, wherein the average particle size of the glass flakes is from 1 to 1000 μm.

6. A pigment according to claim 5, wherein the average particle size is from 1 to 500 μm.

7. A pigment according to claim 6, wherein the average particle size is from 1 to 200 μm.

8. A pigment according to claim 1, wherein said glass flake comprises a second material having a refractive index of less than 1.7.
